(19) United States
(12) Patent Application Publication
(10) Pub. No.: US 2026/0059223 A1
(43) Pub. Date: Feb. 26, 2026

(54) REMOVABLY ATTACHABLE SENSOR MODULE

(71) Applicant: Microsoft Technology Licensing, LLC, Redmond, WA (US)

(72) Inventors: James Hao-An Chen LIN, Issaquah, WA (US); Michael Cameron GORDON, Sammamish, WA (US); Denys V. YAREMENKO, Bellevue, WA (US); Devin Samuel Jacob CAPLOW-MUNRO, Seattle, WA (US); Mauricio Kazuki DEGUCHI YAMAMOTO, Santa Clarita, CA (US); Angie Crystal THAI, Renton, WA (US)

(73) Assignee: Microsoft Technology Licensing, LLC, Redmond, WA (US)

(21) Appl. No.: 18/811,460

(22) Filed: Aug. 21, 2024

(51) Int. Cl. H04R 1/10; G01S 7/481; G03B 9/26

(52) U.S. Cl. CPC H04R 1/1091; G01S 7/4813; G03B 9/26

(57) ABSTRACT

Examples that relate to sensor modules removably attachable to wearable audio devices are disclosed. In one example, a removable sensor module comprises a light sensor, a fixed magnet, and a moveable shutter. The moveable shutter comprises a bistable magnet that repels the fixed magnet to urge the shutter into either a privacy position that blocks a field of view of the light sensor or an open position that does not block the field of view of the light sensor.

### BACKGROUND

Sensors in wearable devices can process and communicate information from the surrounding environment to a user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed and further described below that relate to sensor modules removably attachable to wearable audio devices. In one example, a removable sensor module comprises a light sensor, a fixed magnet, and a moveable shutter. The moveable shutter comprises a bistable magnet that repels the fixed magnet to urge the shutter into either a privacy position that blocks a field of view of the light sensor or an open position that does not block the field of view of the light sensor.

In another example, a wearable audio device comprises a sensor module removably attached to the wearable audio device. The sensor module comprises a light sensor, a fixed magnet, and a moveable shutter. The moveable shutter comprises a bistable magnet that repels the fixed magnet to urge the shutter into either a privacy position that blocks a field of view of the light sensor or an open position that does not block the field of view of the light sensor.

In another example, a method for urging a shutter into either a privacy position or an open position is provided. In a sensor module removably attachable to a wearable audio device, the sensor module comprising a light sensor, a fixed magnet, and a moveable shutter comprising a bistable magnet that repels the fixed magnet to urge the shutter into either a privacy position that blocks a field of view of the light sensor or an open position that does not block the field of view of the light sensor, the method comprises utilizing magnetic fields of the fixed magnet and the bistable magnet to move the shutter into the privacy position, and utilizing the magnetic fields of the fixed magnet and the bistable magnet to move the shutter into the open position.

### BRIEF DESCRIPTION OF THE DRAWINGS

FIG. 1 shows one example of a sensor module and a wearable audio device according to examples of the present disclosure.

FIG. 2 shows the sensor module removably attached to the wearable audio device with a shutter in a privacy position.

FIG. 3 shows the shutter in an open position.

FIG. 4 shows an exploded view of the sensor module of FIG. 1.

FIG. 5 shows a partial plan view of the sensor module with the shutter in the privacy position.

FIG. 6 shows a partial plan view of the sensor module with the shutter in the open position.

FIG. 7 shows a partial plan view of another example of a sensor module removably attachable to a wearable audio device according to examples of the present disclosure.

FIG. 8 is a flow diagram of a method for urging the shutter of a sensor module into either the privacy position or the open position according to examples of the present disclosure.

### DETAILED DESCRIPTION

Wearable audio devices, such as headphones, watches, and other computing devices attachable to the body or clothing, can include one or more sensors for collecting information from a user's environment. However, the sensor's collection of such data can create privacy concerns with a user.

Accordingly, the present disclosure describes sensor modules attachable to a wearable audio device that include one or more features that selectively prevent a light sensor from acquiring information from the user's environment. In some examples and as described in more detail below, sensor modules of the present disclosure include a user-moveable shutter comprising a bistable magnet configured to urge the shutter into either a privacy position that blocks a field of view of a light sensor or an open position that does not block the field of view of the sensor. Advantageously and in this manner, sensor modules of the present disclosure provide a user-actuatable shutter that both selectively prevents the light sensor from collecting data and retains the shutter in the user-desired position. Additionally and in some examples, the sensor module comprises a switch that is opened to disconnect the light sensor from a power source when the shutter moves to the privacy position. Advantageously, in these examples the switch provides a second layer of privacy protection by electrically disabling the sensor module.

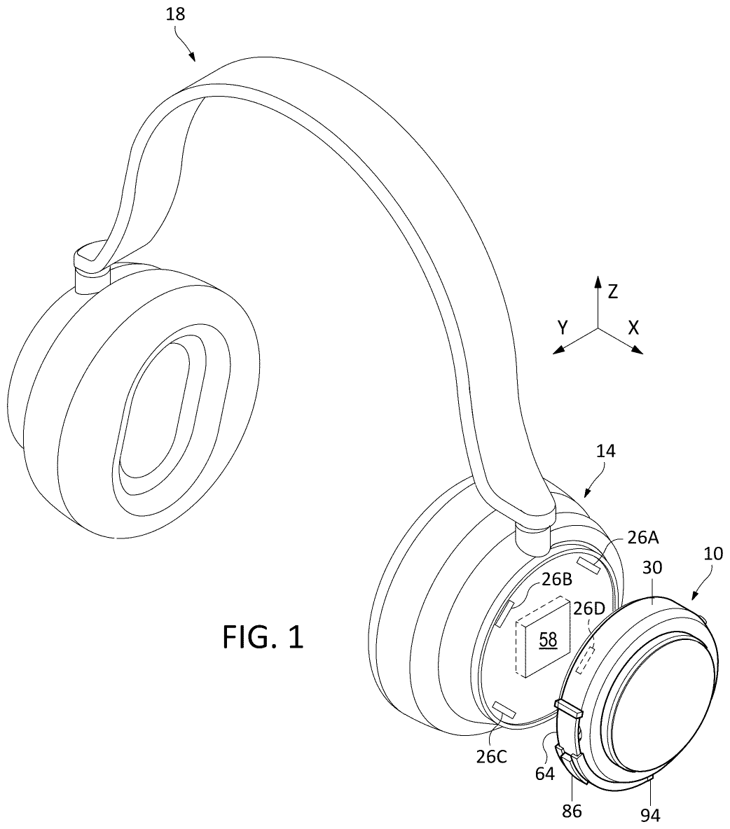

FIGS. 1-7 show examples of a sensor module 10 removably attachable to a wearable audio device according to aspects of the present disclosure. In the present example and as described in more detail below, the sensor module 10 is removably attached to a left ear assembly 14 of headphones 18. In some examples, the sensor module 10 is additionally or alternatively removably attachable to the right ear assembly of headphones 18, and/or can be attached at different orientations relative to an ear assembly of the headphones.

It will be appreciated that the headphones 18 are merely one example of a wide variety of wearable audio devices with which sensor modules of the present disclosure may be utilized. In other examples, sensor modules of the present disclosure can be utilized with numerous other wearable audio devices having different form factors, capabilities, components, and/or other features. Examples include but are not limited to watches, eyeglasses, and clothing-attachable devices.

In the present example and with reference to FIGS. 1, 2, and 4, the sensor module 10 comprises module attachment magnets 22A-22D that attract corresponding headphone attachment magnets 26A-26D in left ear assembly 14 having opposing polarities to removably secure the sensor module to the left ear assembly. In this manner, the sensor module 10 is easily installed and removably retained in place. Additionally, the sensor module 10 is also easily detached, such as by slightly rotating the sensor module relative to the left ear assembly 14 to break the magnetic attraction.

In one potential advantage of the present disclosure, the removable feature of sensor module 10 enables a plurality of different sensor modules having different sensor(s), combinations of sensors, and/or different capabilities to be easily exchanged and installed on the headphones 18. In this manner, the headphones 18 can be easily modified to have different data gathering capabilities which can enable different user experiences.

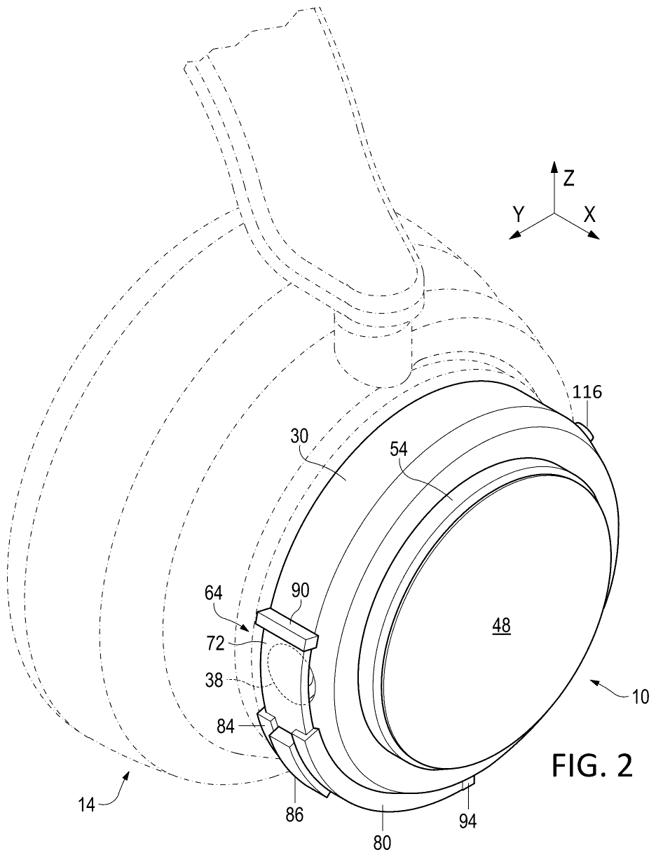

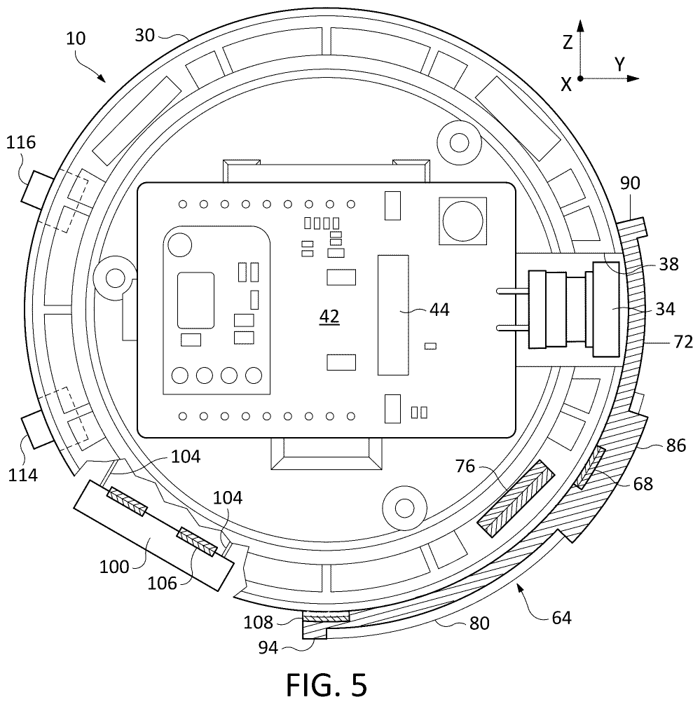

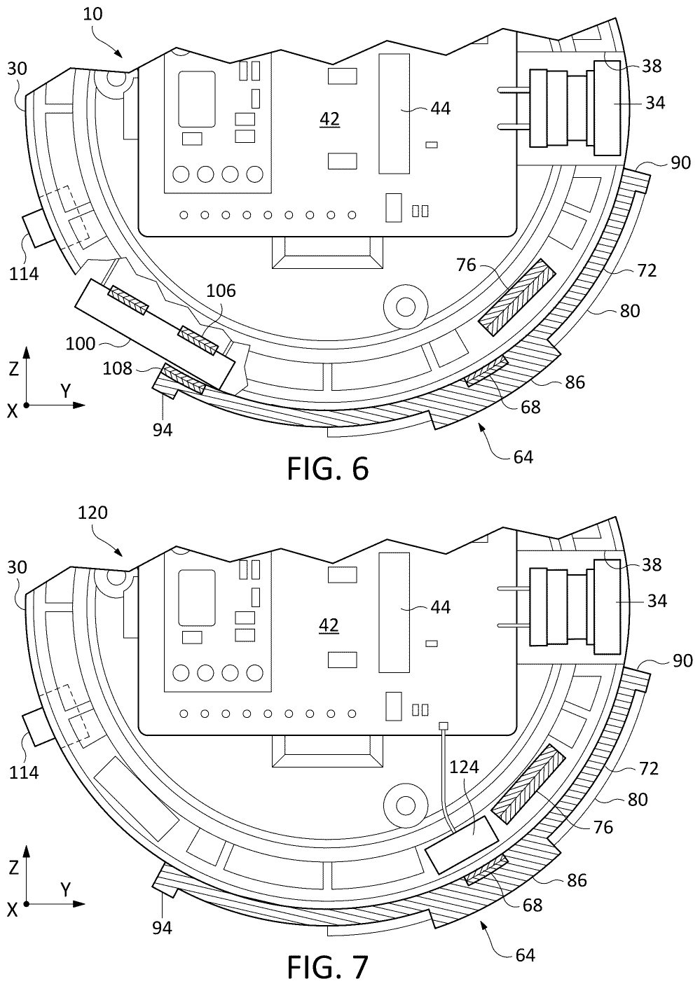

In the present example, with reference to FIGS. 5 and 6 and as noted above, sensor module 10 includes a user-moveable shutter 64 comprising a bistable magnet 68 configured to urge the shutter into either a privacy position that blocks a field of view of a light sensor 34 or an open position that does not block the field of view of the light sensor. With reference also to FIGS. 2-4, the light sensor 34 is located in an aperture 38 formed in the module housing 30. In different examples the light sensor 34 can take a variety of forms and utilize a variety of light detection technologies. Examples of light sensor 34 include, but are not limited to, red-green-blue (RGB) cameras, Infrared (IR) cameras, Lidar sensors, and time-of-flight (TOF) cameras.

In different examples, data collected by light sensor 34 can be processed and utilized to provide a variety of user experiences, including but not limited to describing a user's surroundings via audio generated by headphones 18 and providing audible language translations of visible text or sign languages. In some examples, sensor data is sent to the cloud for processing, and the results are returned to the headphones 18 and/or to an electronic device to which the headphones are communicatively coupled, such as via a Bluetooth protocol. In other examples, sensor data can be processed locally on headphones 18 and/or on a coupled electronic device.

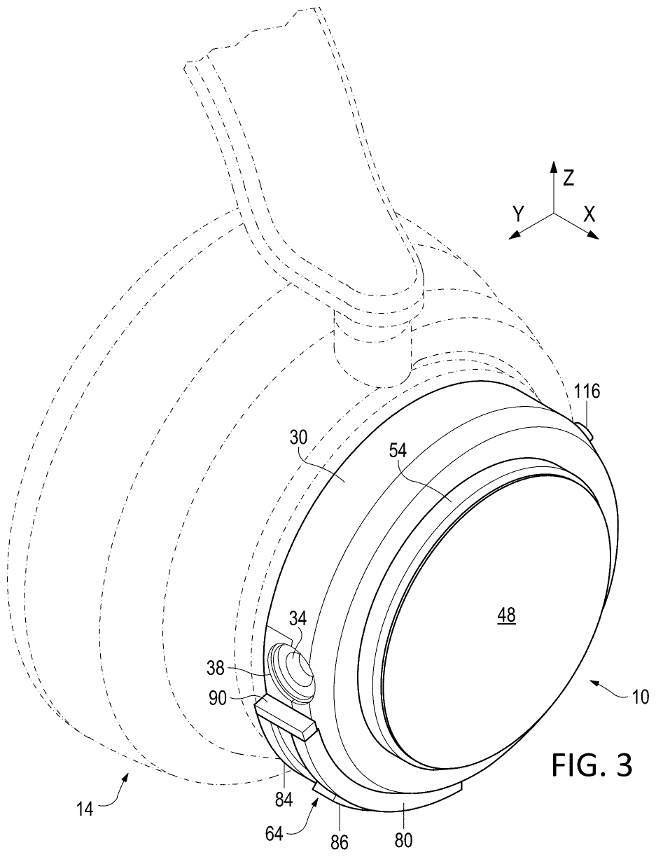

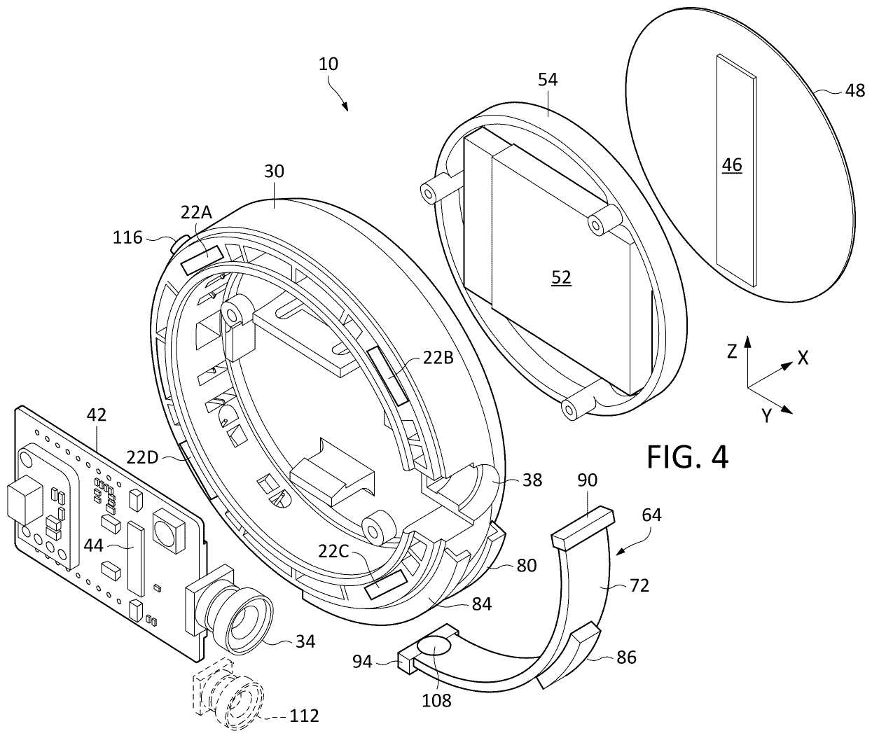

With reference to FIGS. 2, 3, and 5, shutter 64 is slidably coupled to the module housing 30 via a first L-shaped arcuate bracket 80 and opposing second L-shaped arcuate bracket 84. More particularly, shutter 64 comprises an elongated strip 72 that is movably captured by first L-shaped arcuate bracket 80 and second L-shaped arcuate bracket 84. As shown in FIG. 3, a first end stop 90 on a first end of elongated strip 72 abuts the first ends of the first L-shaped arcuate bracket 80 and second L-shaped arcuate bracket 84 when the shutter is in the open position. In a similar manner, a second end stop 94 on a second end of elongated strip 72 abuts the opposing second ends of the first L-shaped arcuate bracket 80 and second L-shaped arcuate bracket 84 when the shutter is in the privacy position (See FIGS. 1 and 4). As shown in FIGS. 5 and 6, bistable magnet 68 is seated in the elongated strip 72. Advantageously, this configuration enables the user to easily slide the shutter 64 between the privacy and open positions, such as by pressing protrusion 86 on elongated strip 72 and sliding the shutter to the desired position.

FIGS. 1, 2, and 5 show shutter 64 located in the privacy position in which a portion of elongated strip 72 of the shutter extends over the aperture 38 and light sensor 34 in module housing 30 to block the field of view of the light sensor. With the shutter 64 in this privacy position, a user has an easily-verifiable visual indication that the field of view of the light sensor 34 is physically blocked to prevent the light sensor from collecting data.

In one potential advantage of the present disclosure and as noted above, with reference to FIG. 5 the shutter 64 also comprises bistable magnet 68 and the sensor module 10 comprises a fixed magnet 76 having the same polarity as the bistable magnet 68. In this manner, the magnetic field of the fixed magnet 76 will repel the magnetic field of the bistable magnet 68, thereby advantageously urging the shutter 64 into either the privacy position shown in FIG. 5 or the open position shown in FIG. 6. From one of these positions, when a user moves the shutter 64 toward the opposite position with insufficient force to overcome the repelling force and then releases the shutter, the repelling force will return the shutter to its original position. On the other hand, when the user exerts sufficient force on the shutter to overcome the repelling force and move the shutter past its bistable point, the repelling force will then urge the shutter into the other position. Accordingly, this configuration provides two stable shutter states, a fully open or a fully closed state, where any region in between is unstable and the shutter will be urged to return to either of the two states.

In some examples and in another potential advantage of the present disclosure, sensor module 10 further comprises a switch connecting the light sensor 34 to a power source, such as a module battery 52 housed in a battery cover 54 (see FIG. 4). In these configurations, when the shutter 64 moves to the privacy position, the shutter opens the switch to disconnect the light sensor 34 from the module battery 52. In the present example and with reference to FIGS. 5 and 6, the switch comprises a normally-open reed switch 100 that includes a magnetically-operated component 106. Terminals 104 electrically couple the reed switch 100 to the light sensor 34 and the module battery 52.

With reference to FIG. 5, in this example shutter 64 includes a switch magnet 108 located adjacent to the second end stop 94 of the elongated strip 72. When the shutter is in the privacy position shown in FIG. 5, the switch magnet 108 is spaced from the magnetically-operated component 106 of the reed switch 100, and the normally-open reed switch prevents power from flowing to the light sensor 34. Accordingly, and in another potential advantage of the present disclosure, this configuration provides a second layer of privacy protection by disconnecting the circuit when the shutter is in the privacy position, thereby preventing the light sensor 34 from having any level of activity. In this state, no information from light sensor 34 is being captured, stored, or processed. Accordingly, this configuration provides users with a high level of confidence in the sensor's activity by enabling the user to both physically disconnect the light sensor from power and physically cover the sensor, all with one movement of shutter 64. Additionally, by disconnecting the light sensor 34 from power when the shutter 64 is in the privacy position, this configuration reduces power consumed by light sensor to extend battery life.

With reference now to FIG. 6, when the shutter 64 is moved to the open position, the switch magnet 108 is moved in-line with the magnetically-operated component 106 of the reed switch 100, thereby closing the reed switch to complete the circuit, allowing power to flow to the light sensor 34, and enabling the light sensor to collect information.

In some examples, and to provide another layer of privacy protection, sensor module 10 is configured to prevent the storage or processing of information obtained by light sensor 34 except and until a user input is received that enables storage and/or processing of the information. In the present example, sensor module 10 includes an input button 114 configured to cause data from light sensor 34 to be analyzed upon manual activation of the input button. In this configuration, when shutter 64 is moved to the open position of FIG. 6 and light sensor 34 begins capturing information, such information is not stored, transmitted, or processed until input button 114 is pressed. Advantageously, this configuration provides another layer of privacy protection that ensures information from light sensor 34 is controlled and managed according to the user's desired intention.

In some examples, the sensor module 10 is electrically connected to a power source of the wearable audio device, such as headphones battery 58 shown in FIG. 1. In these examples, the sensor module 10 can establish an electrical connection to the headphones 18 upon attachment, thereby allowing the sensor module to access the headphone's compute power, battery, & transmitter, and directly communicate with the headphones via this connection.

In other examples, a variety of other switch configurations can be utilized, including but not limited to snap-action switches, Hall effect sensors, and any other switch or sensor configuration activated by motion of the shutter 64.

In some examples and with reference to FIG. 4, a printed circuit board (PCB) 42 of the sensor module 10 includes a wireless transmitter 44 that is electrically coupled to sensor module battery 52. Wireless transmitter 44 can be utilized to communicatively couple the sensor module to cloud computing services, such as through a nearby portable device via the Bluetooth protocol. In this manner, analysis and processing of information collected by light sensor 34 can be offloaded to remote servers, thereby reducing the processing load on the sensor module 120, and the corresponding results can be transmitted through Bluetooth to the headphones 18 for audible delivery to the user.

FIG. 7 shows another example of a sensor module 120 according to aspects of the present disclosure. In this example the bistable magnet 68 of shutter 64 is configured to cause a magnetically-operated component of a switch to disconnect the light sensor 34 from its power source when the shutter moves to the privacy position. In this example the switch comprises a Hall effect sensor 124 coupled to a normally open switch that electrically couples light sensor 34 to module battery 52. FIG. 7 shows shutter 64 in the open position in which the bistable magnet 68 is positioned adjacent to the Hall effect sensor 124.

In this position, the magnetic field of the bistable magnet 68 alters the voltage of the Hall effect sensor 124, which in turn causes the sensor to transmit a signal that closes the switch and completes the circuit, thereby allowing power to flow to the light sensor 34 and enabling the light sensor to collect information. Correspondingly, when the shutter 64 is moved to the privacy position in which the shutter blocks the field of view of light sensor 34, bistable magnet 68 moves laterally away from the Hall effect sensor 124, thereby causing the Hall effect sensor to open the circuit and disconnect the light sensor 34 from the power source. Advantageously, this configuration simplifies the design by using bistable magnet 68 to connect and disconnect the light sensor 34 from power, in addition to biasing the shutter 64 to remain in either the privacy position or open position.

In some examples, sensor modules of the present disclosure include two or more light sensors that are controlled by movement of shutter 64 as described herein. FIG. 4 schematically illustrates a second light sensor 112, such as an IR sensor, that can be utilized in other examples of the present disclosure. Advantageously, in examples where two or more light sensors are utilized, the sensors can utilize different light detection technologies to support additional use cases of the sensor module.

In different examples, the light sensor 34, aperture 38, shutter 64 and related components can be positioned in other locations on sensor module 10. In one example, light sensor 34, aperture 38, shutter 64 and related components can be positioned on an opposing side of module housing 30 to orient the field of view of the light sensor to capture information from behind a user wearing headphones 18. In this manner, information related to objects and activity behind the user can be communicated to the user via headphones 18.

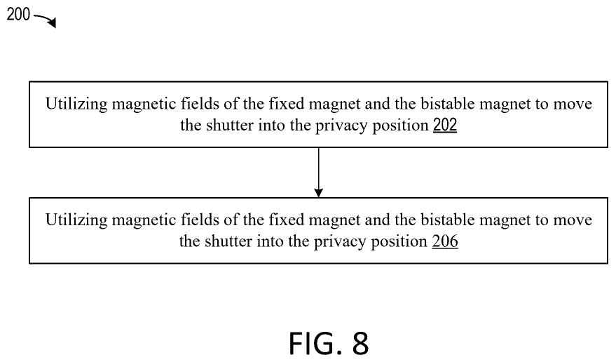

With reference now to FIG. 8, a flow diagram is provided depicting, in a sensor module removably attachable to a wearable audio device, with the sensor module comprising a light sensor, a fixed magnet, and a moveable shutter comprising a bistable magnet that repels the fixed magnet to urge the shutter into either a privacy position that blocks a field of view of the light sensor or an open position that does not block the field of view of the light sensor, an example method 200 for urging the shutter into either the privacy position or the open position. The following description of method 200 is provided with reference to the different examples of sensor modules, wearable audio devices, and related components described herein and shown in FIGS. 1-7. In other examples, method 200 is performed in other contexts using other suitable components.

At 202, method 200 includes utilizing magnetic fields of the fixed magnet and the bistable magnet to move the shutter into the privacy position. At 206 method 200 includes utilizing the magnetic fields of the fixed magnet and the bistable magnet to move the shutter into the open position.

The following paragraphs provide additional support for the claims of the subject application. One aspect provides A sensor module removably attachable to a wearable audio device, the sensor module comprising: a light sensor; a fixed magnet; and a moveable shutter comprising a bistable magnet that repels the fixed magnet to urge the shutter into either a privacy position that blocks a field of view of the light sensor or an open position that does not block the field of view of the light sensor. The sensor module may additionally or alternatively include a switch, wherein the shutter opens the switch to disconnect the light sensor from a power source when the shutter moves to the privacy position. The sensor module may additionally or alternatively include, wherein the switch comprises a magnetically-operated component, the shutter comprises a switch magnet, and the switch magnet causes the magnetically-operated component to disconnect the light sensor from the power source when the shutter moves to the privacy position. The sensor module may additionally or alternatively include, wherein the switch comprises a magnetically-operated component, and the bistable magnet of the shutter causes the magnetically-operated component to disconnect the light sensor from the power source when the shutter moves to the privacy position. The sensor module may additionally or alternatively include, wherein the sensor module further comprises: a wireless transmitter; and a battery configured to provide power to the light sensor and the wireless transmitter. The sensor module may additionally or alternatively include, wherein the sensor module is electrically connected to a power source of the wearable audio device. The sensor module may additionally or alternatively include, wherein the light sensor is selected from an RGB camera, Infrared camera, Lidar sensor, and time-of-flight camera. The sensor module may additionally or alternatively include an input button configured to cause data from the light sensor to be analyzed upon manual activation of the input button. The sensor module may additionally or alternatively include, wherein the light sensor is a first light sensor, the sensor module further comprising a second light sensor utilizing a different light detection technology. The sensor module may additionally or alternatively include a housing, wherein the moveable shutter comprises an elongated strip movably coupled to the housing, wherein the bistable magnet is seated in the elongated strip.

Another aspect provides a wearable audio device comprising: a sensor module removably attached to the wearable audio device, the sensor module comprising: a light sensor; a fixed magnet; and a moveable shutter comprising a bistable magnet that repels the fixed magnet to urge the shutter into either a privacy position that blocks a field of view of the light sensor or an open position that does not block the field of view of the light sensor. The wearable audio device may additionally or alternative include, wherein the sensor module further comprises a switch, wherein the shutter opens the switch to disconnect the light sensor from a power source when the shutter moves to the privacy position. The wearable audio device may additionally or alternative include, wherein the switch comprises a magnetically-operated component, the shutter comprises a switch magnet, and the switch magnet causes the magnetically-operated component to disconnect the light sensor from the power source when the shutter moves to the privacy position. The wearable audio device may additionally or alternative include, wherein the switch comprises a magnetically-operated component, and the bistable magnet of the shutter causes the magnetically-operated component to disconnect the light sensor from the power source when the shutter moves to the privacy position. The wearable audio device may additionally or alternative include, wherein the sensor module further comprises: a wireless transmitter; and a battery configured to provide power to the light sensor and the wireless transmitter. The wearable audio device may additionally or alternative include a power source, wherein the sensor module is electrically connected to the power source of the wearable audio device. The wearable audio device may additionally or alternative include, wherein the light sensor is selected from an RGB camera, Infrared camera, Lidar sensor, and time-of-flight camera. The wearable audio device may additionally or alternative include, wherein the sensor module further comprises an input button configured to cause data from the light sensor to be analyzed upon manual activation of the input button. The wearable audio device may additionally or alternative include, wherein the light sensor is a first light sensor, and the sensor module further comprises a second light sensor utilizing a different light detection technology.

Another aspect provides, in a sensor module removably attachable to a wearable audio device, the sensor module comprising a light sensor, a fixed magnet, and a moveable shutter comprising a bistable magnet that repels the fixed magnet to urge the shutter into either a privacy position that blocks a field of view of the light sensor or an open position that does not block the field of view of the light sensor, a method for urging the shutter into either the privacy position or the open position, the method comprising: utilizing magnetic fields of the fixed magnet and the bistable magnet to move the shutter into the privacy position; and utilizing the magnetic fields of the fixed magnet and the bistable magnet to move the shutter into the open position It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A sensor module removably attachable to a wearable audio device, the sensor module comprising:
a light sensor;
a fixed magnet; and
a moveable shutter comprising a bistable magnet that repels the fixed magnet to urge the shutter into either a privacy position that blocks a field of view of the light sensor or an open position that does not block the field of view of the light sensor.

2. The sensor module of claim 1, further comprising a switch, wherein the shutter opens the switch to disconnect the light sensor from a power source when the shutter moves to the privacy position.

3. The sensor module of claim 2, wherein the switch comprises a magnetically-operated component, the shutter comprises a switch magnet, and the switch magnet causes the magnetically-operated component to disconnect the light sensor from the power source when the shutter moves to the privacy position.

4. The sensor module of claim 2, wherein the switch comprises a magnetically-operated component, and the bistable magnet of the shutter causes the magnetically-operated component to disconnect the light sensor from the power source when the shutter moves to the privacy position.

5. The sensor module of claim 1, wherein the sensor module further comprises:
a wireless transmitter; and
a battery configured to provide power to the light sensor and the wireless transmitter.

6. The sensor module of claim 1, wherein the sensor module is electrically connected to a power source of the wearable audio device.

7. The sensor module of claim 1, wherein the light sensor is selected from an RGB camera, Infrared camera, Lidar sensor, and time-of-flight camera.

8. The sensor module of claim 1, further comprising an input button configured to cause data from the light sensor to be analyzed upon manual activation of the input button.

9. The sensor module of claim 1, wherein the light sensor is a first light sensor, the sensor module further comprising a second light sensor utilizing a different light detection technology.

10. The sensor module of claim 1, further comprising a housing, wherein the moveable shutter comprises an elongated strip movably coupled to the housing, wherein the bistable magnet is seated in the elongated strip.

11. A wearable audio device comprising:
a sensor module removably attached to the wearable audio device, the sensor module comprising:
a light sensor;
a fixed magnet; and
a moveable shutter comprising a bistable magnet that repels the fixed magnet to urge the shutter into either a privacy position that blocks a field of view of the light sensor or an open position that does not block the field of view of the light sensor.

12. The wearable audio device of claim 11, wherein the sensor module further comprises a switch, wherein the shutter opens the switch to disconnect the light sensor from a power source when the shutter moves to the privacy position.

13. The wearable audio device of claim 12, wherein the switch comprises a magnetically-operated component, the shutter comprises a switch magnet, and the switch magnet causes the magnetically-operated component to disconnect the light sensor from the power source when the shutter moves to the privacy position.

14. The wearable audio device of claim 12, wherein the switch comprises a magnetically-operated component, and the bistable magnet of the shutter causes the magnetically-operated component to disconnect the light sensor from the power source when the shutter moves to the privacy position.

15. The wearable audio device of claim 11, wherein the sensor module further comprises:
a wireless transmitter; and
a battery configured to provide power to the light sensor and the wireless transmitter.

16. The wearable audio device of claim 11, further comprising a power source, wherein the sensor module is electrically connected to the power source of the wearable audio device.

17. The wearable audio device of claim 11, wherein the light sensor is selected from an RGB camera, Infrared camera, Lidar sensor, and time-of-flight camera.

18. The wearable audio device of claim 11, wherein the sensor module further comprises an input button configured to cause data from the light sensor to be analyzed upon manual activation of the input button.

19. The wearable audio device of claim 11, wherein the light sensor is a first light sensor, and the sensor module further comprises a second light sensor utilizing a different light detection technology.

20. In a sensor module removably attachable to a wearable audio device, the sensor module comprising a light sensor, a fixed magnet, and a moveable shutter comprising a bistable magnet that repels the fixed magnet to urge the shutter into either a privacy position that blocks a field of view of the light sensor or an open position that does not block the field of view of the light sensor, a method for urging the shutter into either the privacy position or the open position, the method comprising:
utilizing magnetic fields of the fixed magnet and the bistable magnet to move the shutter into the privacy position; and
utilizing the magnetic fields of the fixed magnet and the bistable magnet to move the shutter into the open position.
